(19) United States
(12) Patent Application Publication
(10) Pub. No.: US 2013/0218631 A1
(43) Pub. Date: Aug. 22, 2013

(54) LIFECYCLE CUSTOMER RELATIONSHIP MANAGEMENT SYSTEM

(71) Applicant: Harold L. Peterson, Scotts Valley, CA (US)

(72) Inventor: Harold L. Peterson, Scotts Valley, CA (US)

(73) Assignee: Digital Delivery Networks, Inc., Scotts Valley, CA (US)

(21) Appl. No.: 13/591,200

(22) Filed: Aug. 21, 2012

Related U.S. Application Data
(63) Continuation-in-part of application No. 13/460,233, filed on Apr. 30, 2012.
Application No. 13/460,233 is a continuation-in-part of application No. 13/331,735, filed on Dec. 20, 2011.
Application No. 13/331,735 is a continuation of application No. 09/423,025, filed on Oct. 28, 1999, now Pat. No. 8,126,812.
(60) Provisional application No. 60/058,623, filed on Sep. 11, 1997.

(51) Int. Cl. G06Q 30/00

(52) U.S. Cl. CPC G06Q 30/01; G06Q 30/0241
USPC 705/7.29

(57) ABSTRACT

A system for lifecycle relationship management in an electronics device. Lifecycle data is collected, wherein this includes hardware data with respect to operation of hardware units in the device, utilization data with respect to operation of utilization units in the device, and user data present in the device that identifies the user. A cycle message is transmitted to a remote server on a communications network, wherein this cycle message is based on the lifecycle data. An offer message is received from a remote server on the communications network, wherein this offer message includes offer data that is based on the lifecycle data in at least one prior cycle message. An offer is then presented on a display of the electronics device to the user, wherein this offer is based on the offer data, and a user choice is accepted with an input sub-unit based on the offer.

### CROSS-REFERENCE TO RELATED APPLICATIONS

This is a continuation-in-part of U.S. application Ser. No. 13/460,233, filed Apr. 30, 2012; which is a continuation-in-part of U.S. application Ser. No. 13/331,735, filed Dec. 20, 2011, now pending; which is a continuation of U.S. application Ser. No. 09/423,025, filed Oct. 28, 1999, now U.S. Pat. No. 8,126,812; which is a National Stage Entry of Int. App. PCT/US98/18948, filed Sep. 11, 1998, which claims benefit of U.S. Provisional App. No. 60/058,623, filed Sep. 11, 1997; all hereby incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### TECHNICAL FIELD

The present invention relates generally to marketing that employs electronic devices, and more particularly to such marketing based on the lifecycles of such devices.

### BACKGROUND ART

In 1997 a group including the present inventor saw a solution to a myriad of problems that were plaguing the electronics device industry. In brief, they came to appreciate that storage in such devices was being provided to consumers largely empty and that this was a huge waste of available resources and opportunity. For example, a consumer would buy a new personal computer (PC) and the storage unit (e.g., the hard drive) in this would contain an operating system (OS), a few basic applications intended to make the consumer feel that they were buying more than they really were (derisively termed “shovelware” in the industry), and sometimes also some features-limit samples of software or entertainment media. Overwhelmingly however, the storage units in these devices would simply be empty.

The solution arrived at then was to provide a digital content vending “machine” (DCVM) comprising an infrastructure and an inventory. The infrastructure included a client application that operated the DCVM, particularly to offer, handle payments for, and enable access to the inventory. The inventory was a set of assets of digital content that a user of the DCVM could purchase and then use. In particular, the inventory included local assets, stored in what would have heretofore been empty capacity of the storage unit, that could now be purchased and immediately enjoyed. Since the assets were already local, albeit protected from unauthorized use, the user did not have to travel to a traditional store to purchase an asset or to download it online (at a time when only ˜60% of North Americans had regular Internet access). The assets could also be closely associated with the underlying hardware of the electronics device, thus permitting the tailoring of offers to the users for only digital content that would operate on that device and even permitting the assets to be pre-installed and pre-configured specifically for that device. See e.g., Parent U.S. Provisional Patent App. No. 60/058,623; Int. App. PCT/US98/18948; and U.S. patent application Ser. No. 09/423,025, now U.S. Pat. No. 8,126,812.

Beginning almost immediately, and particularly continuing into 1999-2001, it came to be appreciated that the client application could be enhanced to also serve as a potential solution to many other problems in the industry. For example, that it could be enhanced to additionally serve as the basis for a “Local Portal” (see e.g., U.S. patent application Ser. Nos. 09/798,503 and 12/131,834) and as the basis for a “Behavior Tracking And User Profiling System” (see e.g., U.S. patent application Ser. Nos. 09/797,647 and 12/416,471) and also as the basis for a “Locally Driven Advertising System” (see e.g., U.S. patent application Ser. Nos. 09/797,639 and 12/437,126).

Continuing into 2006-2010, the client application was revised from a simple run-on-command type application into a more integral part of the overall device, specifically to function as a persistent desktop object when the underlying hardware platform was a PC or as an app running under the operating system (OS) of a smart phone or tablet. Concurrently, although the DCVM had all along permitted that the digital content could include software as well as entertainment media and digitally represented services, the offerings were expanded to include considerably more of such media and services. See e.g., U.S. patent application Ser. Nos. 12/131,834; 12/416,471; 12/437,126; 13/331,735; and 13/460,233.

Continuing into 2009-2011, the present inventor came to appreciate that the client application could also serve as a marketing engine for other content that was also local. It was here observed that the underlying hardware resources in electronics devices were being inefficiently designed, installed, and marketed in many end-product electronic devices. For example, 500 and 750 gigabyte magnetic disk drives for installation in a laptop computer consumed essentially the same amount of physical resources, design effort, and manufacturing capability. Similarly, 2 megabyte and 4 megabyte random access memory (RAM) units for the same laptop computer consumed essentially the same amount of physical resources, etc. There were also significant economy-of-scale benefits to designing, assembling, stocking, shipping, etc. all such laptops with the very same disk drives and the very same RAM units, but manufacturers were nonetheless essentially compelled to not do this and to have separate low-end and high-end products, or else risk selling mostly low-price units and then having users self enable the higher-price features.

The solution arrived at here was conceptually similar to how the client application had been used for high-end digital content, only to now protect high-end hardware features from unauthorized use and to closely control authorized access to those features. In the past the user of an electronic device could use the client application to purchase digital content, such as an app or a movie, and the client application would procure a unique password, for instance, that permitted that already locally stored but protected app or movie to then be enjoyed by the user. Now the user of an electronic device could also use the client application to purchase access to a greater capacity feature of the electronics device itself, and the client application could procure a unique password, for instance, and use this to enable the greater capacity feature of the electronics device. See e.g., U.S. patent application Ser. Nos. 11/879,213; 12/505,704; and 12/836,806.

The present inventor now proposes extending the role of the client application or app yet further, to additionally serve as the herein disclosed Lifecycle Customer Relationship Management System.

### DISCLOSURE OF INVENTION

Accordingly, it is an object of the present invention to provide a new form of customer relationship management system.

Briefly, one preferred embodiment of the present invention is a method for lifecycle relationship management in an electronics device employed by a user. Lifecycle data is collected in the electronics device, wherein this lifecycle data includes hardware data with respect to operation of hardware units in the device, utilization data with respect to operation of utilization units in the device, and user data present in the device that identifies the user. A cycle message is transmitted with a communications sub-unit to a remote server on a communications network, wherein this cycle message is based on the lifecycle data. An offer message is received with the communications sub-unit from a remote server on the communications network, wherein this offer message includes offer data that is based on the lifecycle data in at least one prior cycle message. An offer is then presented on a display of the electronics device to the user, wherein this offer is based on the offer data, and a user choice is accepted with an input sub-unit based on the offer.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIGS. 1a-d are overview block diagrams showing how the present invention operates in an overall environment that includes a user's electronics device, wherein FIG. 1a shows representative examples of the user's electronics device, FIG. 1b shows characteristics of the electronics device, FIG. 1c shows types and sources of lifecycle data in the electronics device, and FIG. 1d shows additional details of the overall environment that the electronics devices and thus the invention preferably work in.

FIGS. 2a-b are flow charts that stylistically depict a lifecycle relationship management method that is usable by the present invention, wherein FIG. 2a introduces the method and it operations and FIG. 2b shows some more sophisticated options of the method.

FIG. 3 is a stylized depiction of the lifecycle of a personal computer.

FIG. 4 is a stylized depiction of the lifecycle of a smart phone.

### BEST MODE FOR CARRYING OUT THE INVENTION

A preferred embodiment of the present invention is a lifecycle relationship management system (“LRMS”). As illustrated in the various drawings herein, preferred embodiments of the invention are depicted by the general reference character 10.

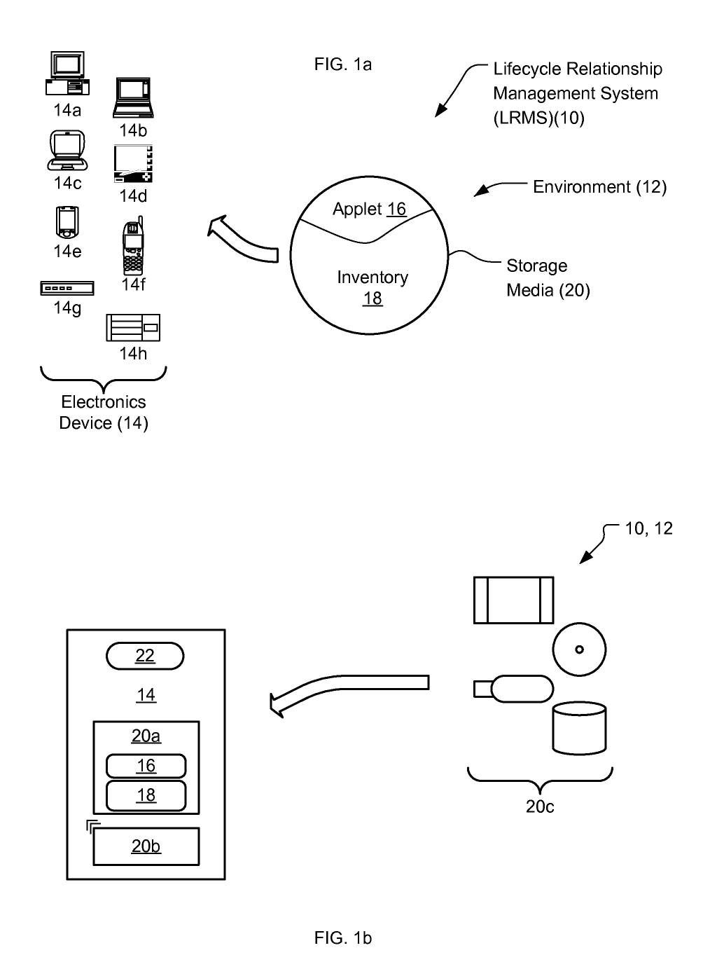

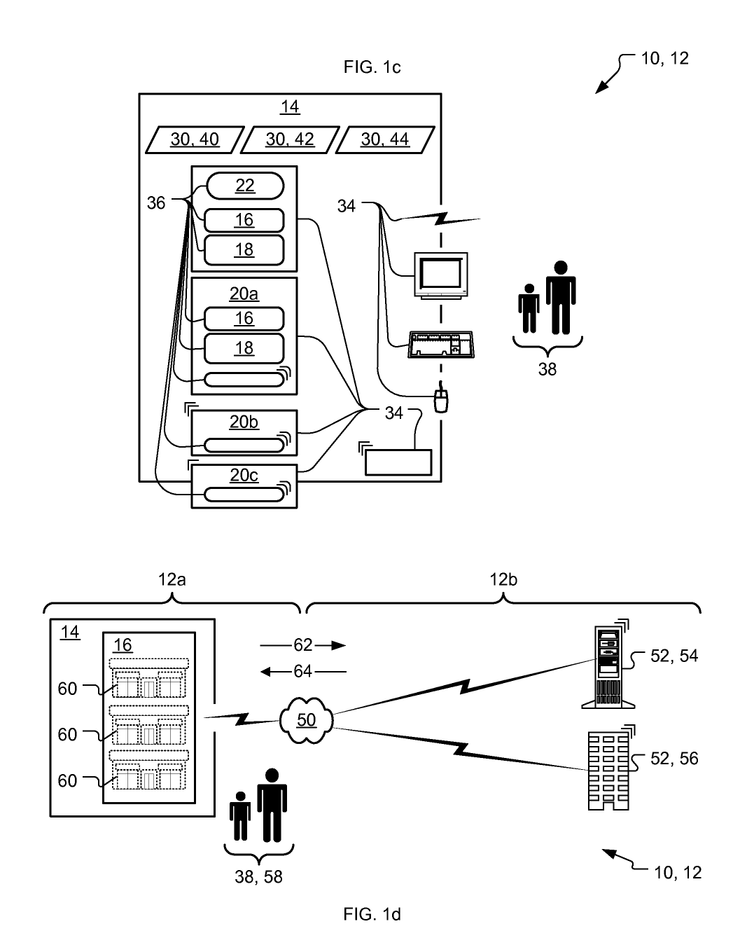

FIGS. 1a-d are overview block diagrams showing how the inventive LRMS 10 operates in an overall environment 12 that includes a user's electronics device 14. The LRMS 10 is part of a client application or app (applet 16), that resides on and operates in the electronics device 14, typically, but not necessarily, with an inventory 18 also present.

As stylistically depicted in FIG. 1a, representative examples of the user's electronics device 14 may be a personal computer (PC 14a), a laptop 14b, netbook 14c, tablet 14d, personal digital assistant (PDA 14e), smart phone 14f, entertainment utility device 14g, or yet other electronic device 14h.

A defining characteristic of the electronics device 14 is that it includes a storage media 20. Historically, in the context of PCs 14a, laptops 14b, and netbooks 14c the principal storage media 20 used have been magnetic disk drives termed “hard” or “fixed” disc drives. Today “solid state” drives (typically employing flash memory circuitry to emulate a traditional hard drive) are increasingly used instead. In contrast, in tablets 14d, PDAs 14e, smart phones 14f, and many types of the other electronic devices 14h the principal storage media 20 used often do not emulate a traditional hard drive (again, flash memory technology is typically employed, but that is due to price and speed considerations and not due to any limitations that are particularly relevant here).

As stylistically depicted in FIG. 1b, another characteristic of the electronics device 14 is that it has an operating system (OS 22) to programmatically control its operation. Today it is common that electronics devices 14 inherently include a volatile memory as well as the static storage media 20, and that the OS 22 is loaded from the storage media 20 into the volatile memory and is executed there. However, the distinction that memory is volatile and that an operating system has to be loaded (or “booted” every time the electronics device is powered on) is one that is expected to change. For present purposes, the electronics device 14 can be viewed as having a single instance of the storage media 20 that is a primary storage 20a, wherein the OS 22 is stored in this, closely works with it, and is loaded for execution from it or actually executes in that primary storage 20a.

Additional instances of fixed storage media 20 may or may not also be present, and if so they are then secondary fixed storages 20b. Removable forms of media also may or may not be present and are then secondary removable storages 20c. Some common current examples of secondary fixed storages 20b are hard and solid state drives that are present in addition to the always present primary storage 20a. Some common current examples of secondary removable storages 20c are external magnetic, solid state, and optical drives (e.g., compact disc (CD), digital versatile disc (DVD), and BluRay (™) disc devices) plug-in modules (e.g., the so-called “thumb drives,” mini and micro SD memories, SIM cards, PCMCIA cards, memory sticks, etc.).

The applet 16 resides in the primary storage 20a of the electronics device 14, from where it may be loaded and executed. Preferably, the applet 16 executes essentially all of the time that the electronics device 14 is on. In contrast to the applet 16, the inventory 18 can theoretically reside anywhere. As a pragmatic matter, however, at least part of the present inventory 18 usually also resides locally in one or more instances of the storage media 20.

Continuing now with FIG. 1c, this shows types and sources of lifecycle data 30 in the electronics device 14. The electronics device 14 includes hardware units 34 such as one or more processors; one or more of the already described types of storage media 20; user input devices such as a keyboard, key pad, touch screen, or other manner of input control; user output devices such as a display or screen, or else an external device used coincidental with the electronics device 14 that also may be used to communicate with users (e.g., many entertainment utility devices 14g use a television as the user output device); and usually some manner of communications link to access a communications network (e.g., a modem, an Ethernet port, wireline or cellular telephone circuitry, etc.). The electronics device 14 also includes utilization units 36. The already discussed applet 16, inventory 18, and OS 22 are all examples of the utilization units 36, as are all instances of software and media “utilized” in the electronics device 14. An electronics device 14 does not “include” its user 38, but understanding may be served here by considering the users 38 as elements in the environment 12 of the LRMS 10.

The lifecycle data 30 available in an electronics device 14 can accordingly be classified as hardware data 40, with respect to operation of the hardware units 34; as utilization data 42, with respect to operation of the utilization units 36; and as user data 44 present in the electronics device 14 that identifies the user 38.

Turning now to FIG. 1d, this shows additional details of the overall environment 12 that the electronics devices 14 and thus the LRMS 10 preferably work in. The environment 12 includes a local environment 12a that includes the electronics device 14 and its current user 38 or users 38, and the environment 12 includes a global environment 12b that includes at least one communications network 50 and at least one remote server 52.

In actual practice, an electronics device 14 is today is often able to access multiple communications networks 50. For instance, a smart phone 14f can access at least one telecommunications network, and that network may further permit access to larger networks such as the Internet. Additionally, most smart phones 14f today can usually also connect to WiFi systems, and thus access local area networks (LANs), wide area networks (WANs), and also the Internet via these. As another example, an entertainment utility device 14g may be able to access an entertainment media provider's proprietary network, as well as the Internet via WiFi or an Ethernet port connecting to a LAN, WAN, and/or the Internet.

Also in actual practice, an electronics device 14 today is typically able to access almost countless remote servers 52, but only those of suppliers 54 and clearinghouses 56 are relevant here. At least one user 38 of the electronics device 14 is potentially also a customer 58 who can make purchases from one or more of the suppliers 54, usually, but not necessarily, with a financial intermediary (that is, a clearinghouse 56) to facilitate the transaction. For this the suppliers 54 and the clearinghouses 56 operate respective remote servers 52.

Historically, the present inventor has provided predecessors of the LRMS 10 to act as vending engines to market goods and devices to the users of electronics devices. These goods and services have also been offered by suppliers, using a client application or app in the electronics device to metaphorically present stores to the users of the electronics device. The applet 16 of the LRMS 10 can continue this practice and present similar stores 60 to customers 58 of the electronics devices 14. This is not a requirement of the LRMS 10, however, and the stores 60 in FIG. 1d are depicted in ghost outline to emphasize this.

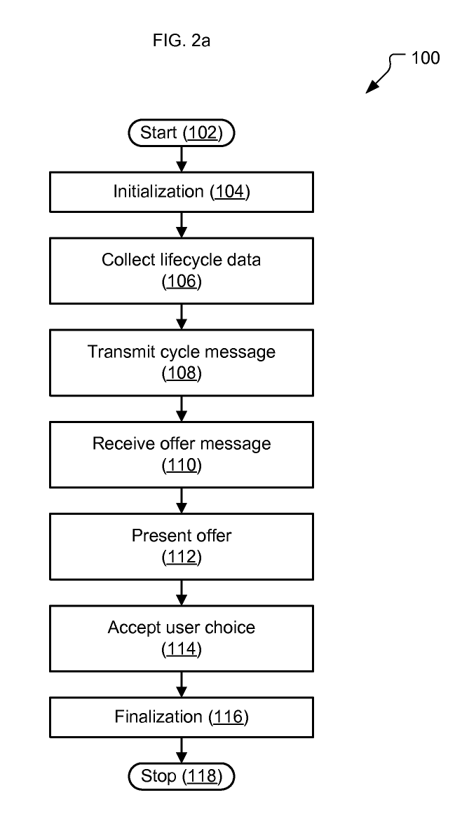

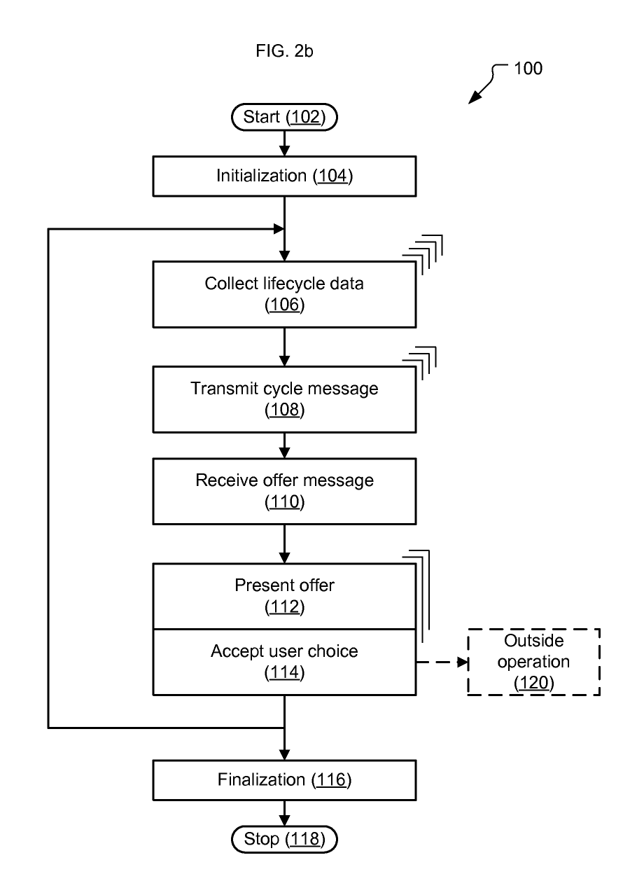

Changing focus now, FIGS. 2a-b are flow charts that stylistically depict a lifecycle relationship management method 100 that is usable in the LRMS 10. Proceeding first with FIG. 2a, in an operation 102 the lifecycle relationship management method 100 starts, and in an operation 104 initialization is performed. When the lifecycle relationship management method 100 is performed by the applet 16, this is where the applet 16 starts and any initialization of it is dealt with.

In an operation 106 instances of the lifecycle data 30 are collected in the electronics device 14. Again, the lifecycle data 30 includes hardware data 40 with respect to operation of the hardware units 34 of the electronics device 14, utilization data 42 with respect to operation and utilization of the utilization units 36 in the electronics device 14, and user data 44 present in the electronics device 14 that identifies the user 38 or users 38. For instance, all of the electronics devices 14 will inherently include a processor (i.e., a hardware unit 34), an operating system (OS 22)(i.e., a utilization unit 36), and have some “identity” relationship with a user 38 of the electronics devices 14. The speed of operation of the processor is an example of hardware data 40, the current version of the OS 22 is an example of utilization data 42, and the user name of the user 38 is an example of user data 44.

In an operation 108 a cycle message 62 (FIG. 1d) is transmitted to a remote server 52 (e.g., to one of the suppliers 54). The cycle message 62 is based on the lifecycle data 30, and typically includes all three types of lifecycle data.

In an operation 110 an offer message 64 (FIG. 1d) is received from a remote server 52 (typically but not necessarily the same remote server 52 that the cycle message 62 was sent to). The offer message 64 includes offer data that is based on the lifecycle data 30 and analysis of it. For instance, continuing with the examples of the lifecycle data 30 introduced above, the speed of operation of the processor may be slow by now current standards, and an offer message could therefore include data on the benefits of upgrading the processor or outright replacing the electronics device 14. Similarly, the version of the OS may be older, and an offer message 64 could therefore include information about updating to a newer version of the OS 22 or upgrading to a newer generation of the OS 22. Such offer messages 64 can particularly be tailored to the actual user 38 of the electronics device 14. For example, if the electronics device 14 is a smart phone 14f and has been given by a parent to their child, offer messages 64 for goods or services of interest to the child can be sent. Alternately however, if the smart phone 14f is primarily used by the child but presently being used by the parent, offer messages 64 for goods or services of interest to the parent can be sent (e.g., ones the parent may want in or on their child's telephone, like ones to disable spy-ware or to prevent access to age inappropriate media).

In an operation 112 an offer is presented to the user 38 on a display of the electronics device 14 (or on some equivalent; e.g., a television if the electronics device 14 is an entertainment utility device 14g). This can simply be the offer message 64 from operation 110, but that need not literally be the case. For instance, the offer might be based on the content of the offer message 64 and other criteria, such as the user 38 having just complete a long telephone call and now offering a different calling plan with more minutes included in the basic cost.

In an operation 114 a choice, that is, a reply to the offer is accept from the user 38. The choice may be that they are not interested, inferred from their simply and promptly dismissing the offer or accessing another app (say, in a smart phone 14f where the act of activating the calling app usually dismisses whatever other apps are running). Or the choice may be an affirmative one, wherein this operation 114 can branch to an appropriate other method and a commercial transaction can ensue. Or the “choice” here can be a more nuanced and granulated instance of utilization data 42. For instance, if the user 38 did not dismiss the offer for 10 seconds last week, that is utilization data 42 that could have been noted then (and kept locally or sent in any subsequent cycle message 62). And if the user 38 waits 15 seconds before dismissing the same or a similar offer today, this is additional utilization data 42 that may merit a cycle message 62 now, a revised offer, etc.

In an operation 116 finalization is performed and in an operation 118 the lifecycle relationship management method 100 stops. When the lifecycle relationship management method 100 is performed by the applet 16, this is where any finalization of the applet 16 is dealt with and where it stops execution in the electronics devices 14.

Proceeding now with FIG. 2b, some more sophisticated options of the lifecycle relationship management method 100 are presented. First, the applet 16 can run essentially all of the time that the electronics device 14 runs, so operation 102 and operation 104 can be essentially part of the device's the power-on or wake-up scenario and the operation 116 and operation 118 can be essentially part of the device's the power-off or sleep scenario. Operations 106 through 114 can be repeatedly sequenced through (looped), with a new instance of operation 106 (collecting new lifecycle data) commencing after a prior instance of operation 114 (accepting a user's choice).

Another option here is for operation 106 to collect, classify, and aggregate many instances of the lifecycle data 30 before the lifecycle relationship management method 100 proceeds to operation 108. For instance, the utilization of the hardware units 34 over time may be noted, or the burden that the utilization units 36 put on the hardware units 34 over time may be noted, or how many different users 38 employ the electronics device 14 over a period of time may be noted. Individual instances of these as lifecycle data 30 may not merit sending a cycle message 62, but collectively they may, say, to tailor offers of a more powerful device, for more feature-rich applications or apps, or for additional, individual devices for each user 38. Accordingly, operation 106 is stylistically depicted as potentially including many sub-operations before operation 108 follows.

Similarly, another option here is for operation 108 to occur multiple times before the lifecycle relationship management method 100 proceeds to operation 110. For instance, multiple cycle messages 62 may be sent that indicate that the electronics device 14 is running at near maximum capability, but there is no point in sending an offer message 64 yet if the electronics device 14 has the highest capability currently available. Of course, by reverse implication, sending an offer message 64 as soon as a device with higher capability becomes available may result in the user 38 buying that device. Moreover, even if a user 38 does not immediately upgrade, they may appreciate that the lifecycle relationship management method 100 is saving them having to continually monitor the state of the market for emerging similar devices.

In contrast to operation 106 and operation 108, operation 110 can occur more sparingly. For instance, it can occur only as frequently as there is something substantial to offer. Moreover, the offer messages 64 can each include an entire campaign of offer related data, such as information about a new device's enhanced hardware performance as well as about its software features. Thus, when previous cycle messages 62 have shown that an existing electronics device 14 is being used near its hardware capacity, a first offer can be presented that emphasizes the enhanced hardware performance of a new device being offered. And if the user 38 continues using the existing electronics device 14, a second offer can be presented that emphasizes the enhanced software features of the new device, etc. In this manner, a campaign of offers can be tailored and presented without boring and possibly alienating the user 38.

Operation 112 and operation 114 here stylistically show multiple offers and user responses, potentially based on operation 110 providing data for this as just discussed, or simply as traditional offer repetition. Operation 112 and operation 114 are stylistically shown together here because, in some manner, every offer begets a choice by the user 38. They may affirmatively accept an offer in the context of the electronics device 14, they may affirmatively pursue the offer in some other manner, they may affirmatively reject the offer, or they may indirectly reject the offer.

As discussed elsewhere herein, the lifecycle relationship management method 100 is performable by an applet 16, and the present inventor has developed the applet 16 as an enhancement of applications and apps developed previously for a “vending machine.” Initial embodiments of such machines vended digital content type assets, such as software applications or apps, entertainment media, and tokens for services. Subsequent embodiments of such machines additionally are able to vend hardware capability type assets, for instance, when a basic capability is present and enabled and higher capabilities are present but not enabled until purchased. If an electronics device 14 has any of these inventory assets already present, the user 38 can affirmatively accept an offer right then and there, and have the asset enabled, turned on, etc. and be usable immediately.

Alternately, the user of the lifecycle relationship management method 100 can affirmatively pursue an offer by accepting it offline, or by asking for more information, or by essentially any other manner of response short of outright acceptance or rejection. FIG. 2b stylistically shows this with an “outside” operation 120. The range of possibilities and scenarios for such operations 120 is huge, so let us consider just one hypothetical. Say that a user 38 has a smart phone 14f, and that they used it once last month and twice so far this month to view pages at the BMWUSA website. With an appropriately set-up applet 16 and a savvy supplier 54, this user's smart phone 14f can be sent an offer message 64 offering its user 38 details about BMW (™) automobiles, or offering them a test drive. Our society is not at the stage, at least not yet, that people purchase or lease automobiles using just a smart phone 14f, but with the present invention it is no longer fanciful that our electronics devices 14 can play an important role in marketing any manner of goods or services and converting users 38 into customers 58.

Philosophers have devoted considerable thought to the nature of life cycles. The ancient Hindus developed that the belief that life has four cycles, whereas some modern thinkers identify ten or even twelve cycles. The scheme contemplated by ancient the Greek philosopher Claudius Ptolemy is probably best known, viewing the human life as having seven stages (birth and the infant stage, the childhood stage, the teenage and early adult stage, the young adult stage, the adult stage, retirement, and the elderly stage until death).

Applying the principle of a lifecycle to an electronics device 14 here may initially seem, but it is perhaps more easily reconciled grasped if one considers that this usually more one a matter of perception in the human mind of a user 38 rather than a literal principle in nature. In particular, this view of a lifecycle is relevant here as it applies in the minds of customers 58 and therefore also suppliers 54.

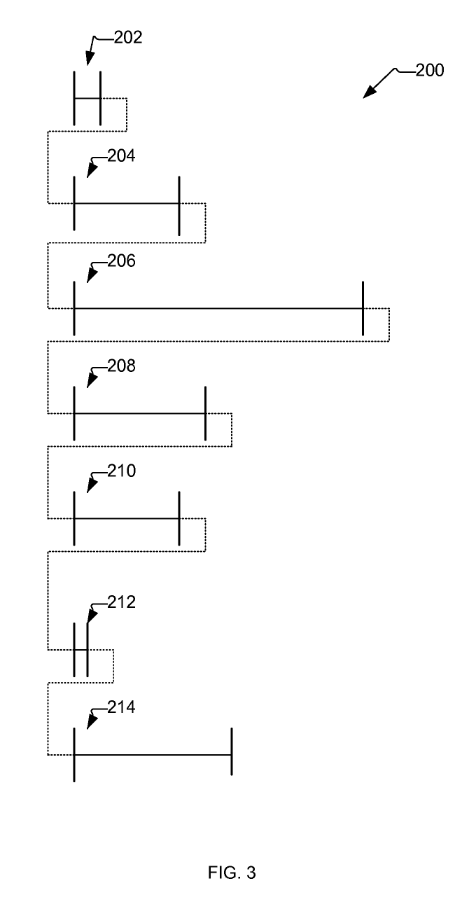

FIG. 3 is a stylized depiction of the lifecycle 200 of a typical personal computer (PC 14a). Although the analogy is somewhat strained, this can be related to Ptolemy's seven stages of life.

In a first stage 202 the PC 14a is manufactured and procured by a customer 58. At this stage the consumer 58 regards the PC 14a as new, and they configure it and familiarize themselves with it. This stage may entail adding necessary hardware units 34 to the PC 14a, such as a display or speakers, if the supplier 54 did not include them. Basically, however, this is very brief stage where the customer 58 expects the PC 14a to turn on and little else.

In a second stage 204 the customer 58 regards the PC 14a as a work in progress, and they particularly add major utilization units 36 to make the PC 14a functional for their purposes. For example, they may add an Internet access service. Then they likely will add security software (Norton (™) or McAfee (™) Internet security suite). They may add a full-featured word-processor program (e.g., Corel's Wordperfect (™)) or an office suite of programs (e.g., Microsoft's Office Professional (™)), or graphics or media creation programs (e.g., Adobe's Photoshop (™) or Audition (™)), etc.

In a third stage 206 the customer 58 regards the PC 14a as being in its prime. They have has added the major functionality they want to the PC 14a, and they now primarily make maintenance and occasional impulse changes to it. For instance, they may add a secondary fixed storage 20b or replace the existing primary storage 20a with a larger capacity unit. Or they may replace an existing optical secondary removable storage 20c with a faster unit. If a program with substantial new features enters the market they may purchase and add the utilization unit 36 to the PC 14a, but by-in-large most software purchases here are of updates and upgrades or are impulse based ones of niche products as the customer 58 becomes aware of their existence. In contrast, this is the main stage when the customer 58 or customers 58 using this PC 14a will typically purchases entertainment, education, etc. media types of utilization units 36.

In a fourth stage 208 the customer 58 regards the PC 14a as still usable but approaching retirement. They regard the PC 14a now as old but still reliable, worth minimally maintaining as such, but beyond the point for adding most new features or impulse purchases. The customer 58 here will typically install free software updates but not purchase and install software upgrades. The purchases of media here fall off as the user avoids real or imagined frustration due to a feeling that PC 14a is not able to handle such as well as now contemporary electronics devices 14.

In a fifth stage 210 the customer 58 regards the PC 14a as elderly and has decided to replace it. They makes minimal demands on it, expect little of it, and expend a minimum of money, time, and effort on it. In essence, the customer 58 cease to be a customer in any respect for the PC 14a and they are just a user 38.

In a sixth stage 212 the user 38 replaces the PC 14a and regards it as dead, but often still physically retains possession of it. Unlike when humans and animals dies, we tend to keep our dead electronic devices 14 around for some time. We dwell on the original and lifetime investments we have made in the PC 14a and we do not want to simply dispose of it. We sometimes think that we can re-task it into some other role or that we can give it to another party that can do this.

And in a seventh stage 214 the PC 14a leaves the control of the user 38. Sometimes the user 38 does give the PC 14a away to another user, and sometimes they “do the right thing” by properly taking it to an environmentally appropriate disposal facility, but all to often into trash heap the PC 14a goes and becomes an eyesore and a burden for us all (analogous somewhat to burial of the dead).

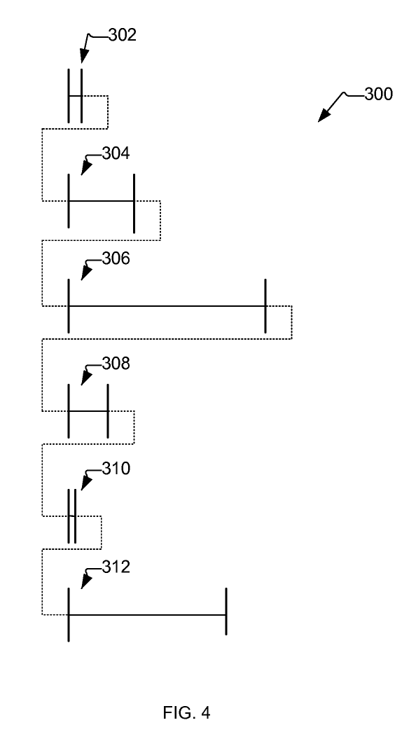

FIG. 4 is a stylized depiction of the lifecycle 300 of a smart phone 14f. Here any attempt at an analogy to Ptolemy's seven stages of life would likely be nonsensical.

In a first stage 302 the customer 58 purchases the smart phone 14f. Typically any related hardware units 34 are purchased concurrently. For instance, a protective case, an extra AC wall-plug charging unit, and an auto charging unit may be purchased here.

In a second stage 304 the customer 58 regards the smart phone 14f as a work in progress, and they go on a buying spree for software type utilization units 36. They add apps, and delete apps, and seek out and add other apps if they liked a particular functionality but find the app providing that functionality to be wanting in some manner. The customer 58 may also buy media types of utilization units 36, such as ring-tones, e-books, songs, and movies. But by-in-large these are isolated purchases to test any play with functionality.

In a third stage 306 the customer 58 regards the smart phone 14f as being in its prime. They have added the functionality they want, and they primarily now make maintenance and occasional impulse changes to the smart phone 14f. For instance, they may read the review of a new app and then procure and install a copy of it. By-in-large here, however, most purchases are either of media type utilization units 36 (e.g., e-books, songs, and movies) or they are of general products where the smart phone 14f is used to research and/or consummate the purchase. For example, the customer 58 may see a home entertainment center (entertainment utility device 14g) at a traditional “big box” store, photograph the bar code on the box and use a shopping app to get comparison prices from on-line suppliers 54, or use the app to save one result in such a supplier's wish list utility, and then order that product hours or days later when they revisit the site and use the smart phone 14f to order the product from that supplier 54. In this scenario the hypothetical home entertainment center is not usable with the smart phone 14f. It is merely a generic product, but one here where the smart phone 14f is intimately involved in the research, choice, and purchase of the generic product by the customer 58.

In a fourth stage 308 the customer 58 regards the smart phone 14f as elderly and decides to replace it. In essence, the customer 58 cease to be a customer in any respect for smart phone 14f and they are now just a user 38. [Note, there typically is no approaching retirement stage here.] For may users 38 this stage is very brief, sometimes being a matter of mere seconds or minutes, and often being impulse based after having seen a review or a newer device being demonstrated or flaunted by some manner of celebrity.

In a fifth stage 310 the user 38 regards the smart phone 14f as dead and replaces it, but often still physically retains it, say, tossed in a drawer somewhere and largely forgotten.

And in a sixth stage 312 the smart phone 14f leaves the control of the user 38, albeit all to often ultimately into trash heap (also analogous to burial of the dead).

The examples in FIGS. 3-4 are merely general ones, but they are typical for many electronics devices 14 today. In addition to PC's, many of the points about FIG. 3 clearly also apply to laptops and other larger devices. Similarly, in addition to smart phones, many of the points about FIG. 4 also apply to tablets and other smaller devices.

The examples in FIGS. 3-4, a PC 14a and a smart phone 14f, also serve to illustrate the typical extremes in “refresh rates.” According to one major manufacturer of PC hardware, the average refresh rate for a PC 14a today is 4.7 years. Coincidentally, this same manufacturer estimates that it would increase its sales by US$10B per year if it could reduce this refresh rate to 3.7 years. In contrast, the average refresh rate for a smart phone 14f is barely more than a single year (manufacturers apparently do not bother to measure it, or else do not release their findings).

As has been described herein, the LRMS 10 is well suited to facilitate transactions between customers 58 and suppliers 52 throughout the earlier lifecycle stages (before the dead and buried stages). The present inventor's previous marketing engines were also useful in these stages. The inventive LRMS 10, however, is especially well suited to additionally facilitate transactions between customers 58 and suppliers 52 in the later lifecycle stages, and to endlessly renew the cycle of life for electronics devices 14.

With reference back to FIG. 3, let us again consider the stages 210, 212, and 214 (elderly, dead, buried) of the lifecycle 200 there of the PC 14a. The LRMS 10 is usable during all of these. By sending the cycle messages 62, analysis can be preformed to determine the how elderly the PC 14a really is, versus how elderly the user 38 may subjectively perceive it to be. The offer messages 64 here can particularly address options to extend this elderly stage 210. When the user 38 replaces the PC 14a (by becoming a customer 58 of a new electronics device 14), the LRMS 10 can provide the sales channel between the supplier 54 of the new electronics device 14 and the existing user 38 and now new customer 58. In particular, with the help of the LRMS 10 the supplier 54 can offer trade-ups, trade-ins, delivery and shipment, and all manner of adjacent sales. And ancillary with a trade-in or as an additional service (one in some areas now being mandated by government) the supplier 54 can provide recycling for the old PC 14a.

With reference back to FIG. 4, it can be appreciated that the LRMS 10 can also serve to transition through the stages 308, 310, and 312 (elderly, dead, buried) of the lifecycle 300 there of the smart phone 14f.

In addition to the above mentioned examples, various other modifications and alterations of the inventive LRMS 10 may be made without departing from the invention. Accordingly, the above disclosure is not to be considered as limiting and the appended claims are to be interpreted as encompassing the true spirit and the entire scope of the invention.

What is claimed is:

1. A method (100) for lifecycle relationship management in an electronics device (14) employed by a user (38), wherein the electronics device (14) includes hardware units (34) and utilization units (36), and wherein the hardware units (34) include a display, a communications sub-unit, and an input sub-unit, the method (100) comprising:
collecting lifecycle data (30) in the electronics device (14), wherein said lifecycle data (30) includes hardware data (40) with respect to operation of the hardware units (34), utilization data (42) with respect to operation of the utilization units (36), and user data (44) present in the electronics device (14) that identifies the user (28);
transmitting a cycle message (62) with the communications sub-unit to a first remote server (52) on a first communications network (50), wherein said cycle message (62) is based on said lifecycle data (30);
receiving with the communications sub-unit an offer message (64) from a second remote server (52) on a second communications network (50), wherein said offer message (64) includes offer data that is based on said lifecycle data (30) in at least one prior said cycle message (62);
presenting an offer on the display of the electronics device (14) to the user (38), wherein said offer is based on said offer data; and
accepting with the input sub-unit a user choice based on said offer.
